(19) United States
(12) Patent Application Publication
(10) Pub. No.: US 2025/0181079 A1
(43) Pub. Date: Jun. 5, 2025

(54) MACHINE LEARNING FRAMEWORK FOR CONTROL OF AUTONOMOUS AGENT OPERATING IN DYNAMIC ENVIRONMENT

(71) Applicant: ANDRO Computational Solutions, LLC, Rome, NY (US)

(72) Inventors: Jithin Jagannath, Oriskany, NY (US); Nicholas Joseph Polosky, Albany, NY (US); Andrew Louis Drozd, Rome, NY (US)

(21) Appl. No.: 17/200,106

(22) Filed: Mar. 12, 2021

Related U.S. Application Data
(60) Provisional application No. 62/991,637, filed on Mar. 19, 2020.

(51) Int. Cl. G05D 1/656; G05B 13/02; G05D 101/15

(52) U.S. Cl. CPC G05D 1/656; G05B 13/027; G05D 2101/15

(57) ABSTRACT

Embodiments of the disclosure provide a machine learning framework to control an autonomous agent in a dynamic environment. A system according to the disclosure includes a sensor coupled to the autonomous agent to receive a set of inputs. At least one actuator causes the autonomous agent to perform an action. A controller causes the actuator to perform an action based on the inputs and an operative policy. The controller determines whether the operative policy is terminated, based on the set of inputs. Upon terminating the operative policy, the controller evaluates several candidate policies and selects one of the candidate policies as a new operative policy.

### STATEMENT REGARDING FEDERAL RIGHTS

This invention was made with government support under contract numbers N68335-19-C-0799 and N68335-20-C-0964 awarded by the United States Department of Defense. The government has certain rights in the invention.

### BACKGROUND

### 1. Technical Field

The present disclosure relates to the control of unmanned or autonomous agents, e.g., unmanned aircraft and/or other types of remote controlled vehicles. More specifically, embodiments of the disclosure provide a system, method, and program product for control of autonomous agents through machine learning.

### 2. Background Art

With the recent advancements in machine learning, e.g., deep reinforcement learning and artificial neural network (ANN) based reinforcement learning solutions, the ability to provide increased autonomy in a number of robotics applications has become a realization. Such advancements have been shown to be successful in providing autonomy in robots and vehicles where objectives are stationary and the environment in which the system is deployed changes with low frequency. However, these solutions are often insufficient upon consideration of the dynamic objectives and rapidly changing environments typically encountered in tactical unmanned system (e.g., vehicle) autonomy scenarios. An unmanned system may include a fully or partially automated vehicle such as an unmanned aerial vehicle (UAV). While deep learning solutions have been successfully employed for object avoidance (OA) and collision detection (CD) tasks, and deep reinforcement learning solutions have been successful in tasks such as target following, these solutions fail to generalize appropriately to the unpredictable nature encountered in a tactical environment. Additionally, the aforementioned solutions fail to account for the necessity for operator and machine teaming endemic of UAV control missions. Thus, the task of autonomous UAV control in a tactical environment poses constituent challenges that are yet to be solved in a single generally applicable autonomous solution.

### SUMMARY

The illustrative aspects of the present disclosure are designed to solve the problems herein described and/or other problems not discussed.

Embodiments of the disclosure provide a system for control of an autonomous agent, the system including: a sensor communicatively coupled to the autonomous agent and configured for receiving a set of inputs, the sensor including an environmental sensor and a non-environmental sensor; at least one actuator for causing the autonomous agent to perform an action; and a controller communicatively coupled to the sensor and the at least one actuator, wherein, the controller is configured to perform actions including: causing the at least one actuator to perform the action based on the set of inputs and an operative policy; determining whether the set of inputs indicates termination of the operative policy; valuating a value function for each of a plurality of candidate policies based on the set of inputs, in response to the set of inputs indicating termination of the operative policy; and selecting one of the plurality of candidate policies as a new operative policy.

Further embodiments of the disclosure provide a method for control of an autonomous agent, the method including: causing the autonomous agent to sense a set of inputs via an environmental sensor and a non-environmental sensor; causing at least one actuator of the autonomous agent to perform an action, based on the set of inputs and an operative policy; determining whether the set of inputs indicates termination of the operative policy; evaluating a value function for each of a plurality of candidate policies based on the set of inputs, in response to the set of inputs indicating termination of the operative policy; and selecting one of the plurality of candidate policies as a new operative policy.

Still further embodiments of the disclosure provide a computer program product for control of an autonomous agent, the computer program product including a computer readable storage medium on which is stored program code for causing a computer system to perform actions including: causing the autonomous agent to sense a set of inputs via an environmental sensor and a non-environmental sensor; causing at least one actuator of the autonomous agent to perform an action, based on the set of inputs and an operative policy; determining whether the set of inputs indicates termination of the operative policy; evaluating a value function for each of a plurality of candidate policies based on the set of inputs, in response to the set of inputs indicating termination of the operative policy; and selecting one of the plurality of candidate policies as a new operative policy.

### BRIEF DESCRIPTION OF THE DRAWINGS

FIG. 1 illustrates a schematic diagram of a system for control of an autonomous agent according to embodiments of the disclosure.

FIG. 2 shows a schematic view of an autonomous agent in communication with environmental and non-environmental inputs according to embodiments of the disclosure.

FIG. 3 shows a schematic diagram of a learning architecture integrated with an external software framework according to embodiments of the disclosure.

FIG. 4 shows a schematic diagram of an illustrative system for implementing operational methodologies according to embodiments of the disclosure.

FIG. 5 provides an illustrative flow diagram for implementing an operational methodology according to various embodiments of the disclosure.

### DETAILED DESCRIPTION

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Conventional approaches to autonomous control of autonomous agents conventionally manifest themselves as algorithms that perform simultaneous localization and mapping (SLAM) and structure from motion (SfM). These approaches are concerned with mapping the space around the agent, typically employing a light detection and ranging (LIDAR) sensor for imaging. The fundamental shortcoming of these algorithms is that they require the autonomous agent to remain in place over a significant time to collect sensor data and subsequently map the environment and localize the agent in the environment. In tactical, time-sensitive scenarios, the inefficient usage of both time and power resources render these solutions non-applicable.

While deep learning solutions offer a more instantaneous approach to object avoidance and collision detection, mitigating time and power waste, these solutions do not directly learn how to operate and control an autonomous agent to mission completion. In some cases, an “autonomous agent” may include a fully or partially automated vehicle such as an unmanned aerial vehicle (UAV). The term autonomous agent more generally refers to any device with at least one automated or partially automated function, and thus such functions may be implemented with or without direct input from a user of the autonomous agent. Reinforcement learning solutions have been employed to perform autonomous control in relatively less complex applications such as target tracking. A significant issue with these types of solutions is that the objective the agent has been learned to solve is static. To be deployable in a tactical setting, these solutions need to be augmented to handle dynamic mission plans, broken data links, changing local conditions, etc. and to operate within a human machine team.

Embodiments of the disclosure provide a system, method, and program product for control of autonomous agents. Systems according to the disclosure may include, e.g., a sensor communicatively coupled to the autonomous agent for receiving a set of inputs. The sensor in particular may include an environmental sensor for sensing environmental inputs (e.g., position of the autonomous agent, objects detectable as signals, etc.), and a non-environmental sensor for sensing non-environmental inputs (e.g., direct commands from an operator of the autonomous agent). The sensor(s) may include visual and non-visual sensors, such as cameras, acoustic sensors, and/or other types of currently known or later developed input devices. At least one actuator of the autonomous agent is capable of performing actions, e.g., moving the autonomous agent, interacting with the environment, etc. A controller is communicatively coupled to the sensor and the actuator(s) to control the actuator(s) based on the sensed inputs. The controller causes the actuator(s) to perform actions based on the set of inputs and an operative policy (e.g., continuing with a mission objective). The controller determines whether the set of inputs indicates termination of the operative policy (e.g., a command to temporarily halt or abort the mission). The controller may evaluate a value function of several candidate policies based on the set of inputs, upon terminating the operative policy. Thereafter, the controller selects one of the candidate policies to become the new operative policy.

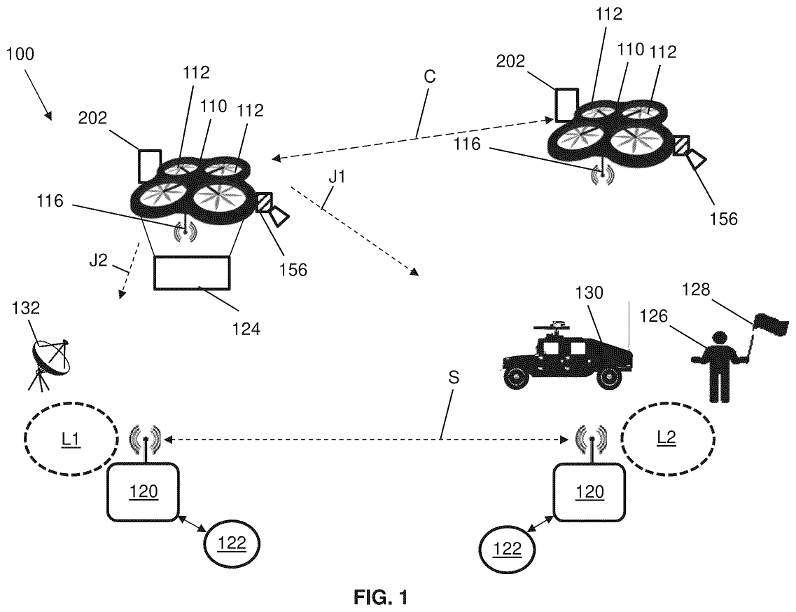

Referring to FIG. 1, a schematic example of an environment 100 is shown, in which one or more elements of a system may operate and/or be provided according to various embodiments of the disclosure. Environment 100 may be in the form of, or referred to as, a “dynamic environment.” A dynamic environment is a setting in which various elements (e.g., several autonomous agents 110, individuals, vehicles, devices, environmental elements such as infrastructure and natural topography) may affect the relevant objectives to be performed and/or the manner in which such objectives are performed. Environment 100 may include one or more autonomous agents 110 configured to perform various operations within environment 100, e.g., moving to various locations and/or interacting with various elements of interest within environment 100. Each autonomous agent 110 may include any currently known or later developed device for performing a function within environment 100, e.g., an autonomous vehicle such as a UAV, a non-vehicle based device for operating within environment 100, and/or various other such devices. Autonomous agent(s) 110 may include one or more actuators 112, e.g., propellers, motors, wheels, other types of propulsion devices, and/or any conceivable instrument for performing actions such as moving from one location to another in environment 100, delivering a payload, collecting a payload, interacting with various persons or devices within environment 100, etc. However embodied, each autonomous agent 110 may represent a single communications node and/or group of communications nodes communicating with other autonomous agents 110 and/or other devices as noted herein. One or more autonomous agents 110 in environment 100 may be configured for wireless radio frequency (RF) communication with other autonomous agents 110 and/or other devices within a relevant communications range.

Autonomous agent(s) 110 may include wireless fidelity (Wi-Fi), hardware for enabling communication with and/or between local area network (LAN) devices within environment 100, and/or autonomous agent(s) 110 in other environments 100 and communicatively coupled to autonomous agent(s) 110 within environment 100. The Wi-Fi infrastructure may be suitable to enable communication between several autonomous agents 110, as Wi-Fi offers a mid-sized network area (i.e., up to approximately three-hundred foot radius) for interconnecting multiple devices. Embodiments of the disclosure may integrate a first type of network infrastructure (e.g., Wi-Fi as noted above) with a second, distinct type of network infrastructure configured to allow communication over larger distances (e.g., several miles as compared to several-hundred feet). Each autonomous agent 110 thus may include, e.g., a long-range transceiver (simply “transceiver” hereafter) 116 for establishing communication between autonomous agents 110 within environment 100. In some cases, transceiver 116 and/or a portion of autonomous agent 110 may act as a short-range transceiver for permitting communication between autonomous agents 110 that are close to each other. In any case, transceiver 116 may be provided in the form of an RF antenna, and/or any conceivable long-range transmission components (including RF hardware and/or other types of communication infrastructure) for transmitting data packets between autonomous agents 110 within environment 100. According to one example, a low power wide area network (LPWAN) may be provided via the LoRaWAN™ specification or other proprietary, commercially-available technology for wireless data communication.

However embodied, transceiver(s) 116 may enable low power, long-range links between autonomous agents 110, and with other transceivers 116 regardless of whether they correspond to a particular autonomous agent 110. Autonomous agent(s) 110 and/or transceiver(s) 116 thus may not necessarily rely on conventional communications infrastructure, particularly where such infrastructure is unavailable when autonomous agent 110 is traveling from one location to another, remote location (e.g., when performing an operation as part of a mission). In any case, a user once connected to autonomous agent 110 may access various forms of data (e.g., maps, authority contact information, communications, and internet-enabled services based on availability of gateway) through transceiver 116. Environment 100 may also include one or more network gateways 120 capable of interfacing with autonomous agent(s) 110. Each network gateway 120 may be embodied as any currently known or later developed component for providing an access point to external networking technology, and/or means for providing software updates and/or instructions to autonomous agent 110 in the communications range of network gateway 120. For instance, the network gateway may include one or more of, e.g., a mission control tower, a remote network base, a server, other mobile or immobile transceiver assembly (ies) in communication with conventional networking infrastructure, and/or similar devices. One or more users 122 of autonomous agent(s) 110 may access autonomous agent(s) 110, e.g., via an application on another autonomous agent 110, directly through a personal device, and/or through network gateway(s) 120 in communication with autonomous agent(s) 110.

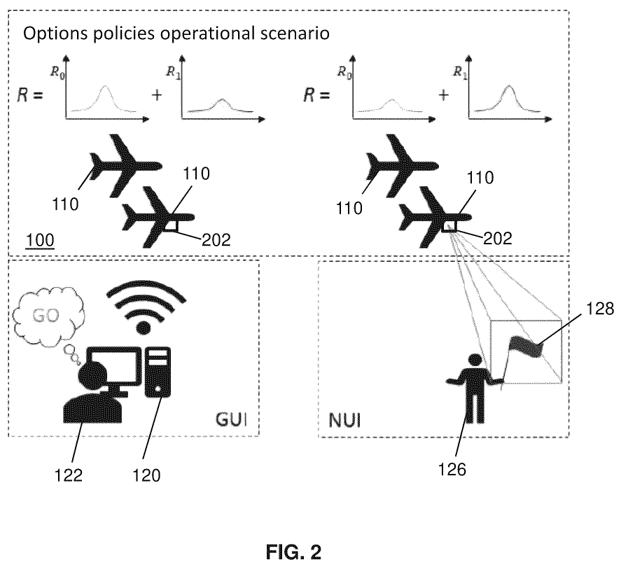

Referring to FIGS. 1 and 2 together, autonomous agent 110 may be deployed to complete an objective such as a mission, delivery, etc. In such an example, autonomous agent 110 may contain a payload 124 (e.g., supplies, materials for processing, munitions, personnel, etc.) for transport. Environment 100 may include various elements 126 (including, e.g., humans, machines, other autonomous agents, infrastructure, and/or various natural features). Each element 126 may operate independently of autonomous agent(s) 110, and thus cause environment 100 to be a dynamic environment. Elements 126 may be capable of displaying, or may embody, environmental cues 128 potentially affecting whether autonomous agent(s) 110 need to begin implementing a different operative policy. Control of autonomous agent(s) 110 is especially complex when there are many constituent objectives that comprise the overall mission objective (e.g., deliver a payload to a target location while maintaining communication fidelity and preventing damage to autonomous agent(s) 110). Some objectives may be present in several scenarios (e.g., attempting to reestablish a broken data link to other autonomous agent(s) 110 and/or network gateway(s) 120, minimization of power consumption), and others which are not (e.g., delivery of a payload to different types of locations, refueling a vehicle, and/or other unique objectives). Environment 100 may be further complicated by elements 126 in the form of, e.g., an operator-controlled system 130 (shown by example as being a manually driven vehicle), another device 132 that may or may not be autonomously operated, as well as personnel and/or other types of elements 126.

These changes in objective and/or priority may be sensed via environmental cues 128, and/or direct commands from a user of autonomous agent(s) 110. In some cases, user(s) 122 may transmit non-environmental inputs to autonomous agent(s) 110 using a graphical user interface (“GUI”), while autonomous agent(s) 110 may receive environmental inputs via a natural user interface (“NUI”) system within controller 202. Embodiments of the disclosure account for multiple objectives and account for certain objectives becoming more relevant and/or less relevant with time. Embodiments of the disclosure use machine learning of multiple tasks to provide a generalized solution for autonomous agent 110 behavior, which may be beneficial for the applicability to other autonomous systems.

Effective human-machine teaming between user(s) 122 and autonomous agent(s) 110 is important to the overall fidelity and execution of the mission and its objectives. While autonomous agent(s) 110 may be partially or even fully autonomous in various capacities, a human in the loop may quickly signal changing mission objectives and suggest courses of action to autonomous agent(s) 110. Contrarily, autonomous agent(s) 110 must be able to signal back to user(s) 122 all mission relevant information and must be able to override any course of action suggested by user(s) 122 that is deemed impossible to perform. Embodiments of the disclosure rely upon both human machine perception, and understanding, to provide operational advantages.

Autonomous agent(s) 110 may include one or more sensor(s) 156 for monitoring element(s) 126 and/or environmental cues 128. Sensor(s) 156 may be directly mounted on autonomous agent(s) 110, or otherwise may be in communication with one or more controllers 202 for governing the operation of autonomous agent(s) 110. In the event that sensor(s) 152 are mounted on autonomous agent(s) 110, sensor(s) 152 may be positioned within, or at a location suitable to visually monitor, various areas of environment 100 where elements 126 and/or environmental cues 128 may exist. Sensor(s) 152 can be provided in the form of any currently-known or later-developed visual or audio-visual capturing system and as examples may include fixed or portable devices including conventional cameras, infrared cameras, light filed cameras, acoustic cameras, magnetic resonance imaging (MRI) cameras, and/or any conceivable number or type of image detection instruments. Additional and/or alternative types of sensor(s) 152 may include, e.g., temperature sensors, pressure sensors, and/or other quantities pertaining to environment 100. Each sensor 152 can be configured to operate at a position suitable to visually monitor environment 100, e.g., through a corresponding electrical and/or mechanical coupling to corresponding portions of autonomous agent(s) 110.

Autonomous agent(s) 110 may include controller(s) 202 communicatively coupled to one or more sensors 156 to perform various functions, e.g., manipulation of actuator(s) 112. The manner in which controller(s) 202 manipulate actuator(s) 112 and/or performs other functions to fulfill an objective may be known as an “operational policy” for autonomous agent 110. For instance, controller 202 may implement an “operative policy” of traveling from a first location L1 to a second location L2 by manipulating actuator(s) 110 to move autonomous agent 110 towards second location L2 in compliance with its current operative policy. Controller 202 can generally include any type of computing device capable of performing operations by way of a processing component (e.g., a microprocessor) and as examples can include a computer, computer processor, electric and/or digital circuit, and/or a similar component used for computing and processing electrical inputs. Example components and operative functions of controller 202 are discussed in detail elsewhere herein. One or more sensor(s) 156 may also include an integrated circuit to communicate with and/or wirelessly transmit signals to controller 202.

In a tactical operating scenarios, mission objectives for autonomous agent 110 and environment 100 itself are dynamic, i.e., subject to changes. For instance, one autonomous agent 110 in environment 100 initially have an overarching goal of delivering payload 124 from a first location L1 to a second location L2. This mission objective may be mathematically modeled, e.g., by way of a “value function” in which possible actions that contribute to the mission objective will increase the output from the value function more than other possible actions. At a given point in time, autonomous agent 110 may be capable of traveling to second location L2 along pathway J1, or traveling to first location L1 along pathway J2. It is understood that any number of locations and/or pathways may be available and/or relevant to autonomous agent 110, and that multiple pathways may be taken to reach one location and/or some locations may not be accessible via any known pathways. Initially, the action of causing actuator 112 to move autonomous agent 110 along pathway J1 toward second location L2 (i.e., in compliance with the current objective) may increase the value function more than causing actuator 112 to move autonomous agent 110 along pathway J2 toward first location L1. Various circumstances, e.g., changes within environment 100 and/or changing needs of user(s) 122, may abruptly modify the objectives of autonomous agent 110 as it acts within environment 100. For instance, element(s) 126 in the form of site personnel may display environmental cue(s) 128 in the form of a flag to “wave off” further supplying of payload(s) 124. In an example where autonomous agent 110 is delivering payload(s) 124 to second location L2 and detects environmental cue 128 “waving off” the supply, a new operative policy must replace the existing operative policy to deliver payload 124. The new operative policy may include a new, revised value function whose output will be greater for actions in compliance with the new objective(s).

Embodiments of the disclosure, as discussed elsewhere herein, are configured to detect environmental cue(s) 128 and prioritize returning to first location L1 via second pathway J2, even if user(s) 122 do not recognize the significance of environmental cue(s) 128 to broader mission objectives. A further example of a changing goal may include, e.g., a situation where autonomous agent 110 loses its data link with network gateway(s) 120 and/or other autonomous agent(s) 110. Embodiments of the disclosure avoid a potential problem of trying to restore a lost data connection at the expense of all other objectives by dynamically changing the operative policy of autonomous agent 110 in response to changing conditions. By this approach, it is possible for autonomous agent(s) 110 to take advantage of machine learning to change its priorities and subsequent actions when detecting a change in environment 100. Such changes in the corresponding value function may be initiated automatically via controller 202, and/or through direct selection(s) from user(s) 122. Various approaches to accommodate changing mission objectives are described herein, and may be implemented via controller 202 of autonomous agent(s) 110.

The efficacy of autonomous agent 110 in achieving its objectives, and switching from one objective to another, will depend not just on user(s) 122 and controller 202 but also on the ability for controller 202 to respond automatically to various inputs and/or the possible unavailability of user(s) 122. Embodiments of the disclosure are more effective than conventional supervised and unsupervised learning approaches to the planning and implementation of tasks performed by autonomous agents. Such tasks may include or rely upon object active recognition and/or scene classification, e.g., by various control systems and/or sub-systems. Embodiments of the disclosure, by contrast, may process environmental and non-environmental inputs in conjunction with signal processing techniques, and may enable “shared perception” or “shared understanding” of environment 100 by responding to and/or prioritizing different types of inputs.

Various embodiments of controller 202 for autonomous agent 110 may use reinforcement learning, as described herein. Reinforcement learning is a learning process capable of being implemented on any device capable of collecting data for environment 100 (e.g., autonomous agent 110 and/or any other device with sensor(s) 152), performing actions within environment 100, and/or observations of environment 100. In reinforcement learning, autonomous agent 110 receives a “reward signal” in the form of environmental and/or non-environmental inputs pertaining to environment 100. The various inputs may indicate, e.g., the status of autonomous agent 110 at the time a reward is given. Over time, autonomous agent 110 undertakes further steps to maximize its cumulative value from rewards by observing environment 100, processing value signal(s) received, and then performing various actions based on these inputs. At each time step, autonomous agent 110 observes a state “s,” chooses an action “a,” receives a reward “r,” and transitions to a new state. The value function(s) that autonomous agent(s) 110 applies may form part of an “operative policy” for governing the actions of autonomous agent 110 in environment 100.

Regarding interaction between autonomous agent(s) 110 and user(s) 122, FIG. 2 provides an example of how an operator in the form of user(s) 122 can interface with autonomous agent(s) 110, and shows an example for the use of options policies, where the operating policy varies throughout the course of a mission, e.g., a single continuous operating period of autonomous agent(s) 110. In the bottom left corner of FIG. 1, user(s) 122 (e.g., an operator in this example) may use a direct interface (e.g., a graphical user interface (GUI)) to interface with autonomous agent(s) 110. An example command of “GO” is provided to autonomous agent(s) 110 via the GUI. In this case, the corresponding constituent candidate policy within the operative model of controller 202 is selected for obeying the command (e.g., shown above autonomous agent(s) 110). Controller(s) 202 may also include an environmental interface (e.g., a natural user interface (NUI)) for identifying and/or interpreting environmental cue(s) 128 (e.g., red flag), e.g., indicating a change in objective. Environmental cue(s) 128 may exist within environment 100 where a mission is undertaken, e.g., at second location L2. The change in objective is reflected in the value function corresponding to the newly selected operative policy, e.g., an increase in one function and decrease in another. Multiple autonomous agent(s) 110 are shown to stress that embodiments of the disclosure may be implemented on swarms of autonomous agent(s) 110, each using and/or interfacing with an external software architecture.

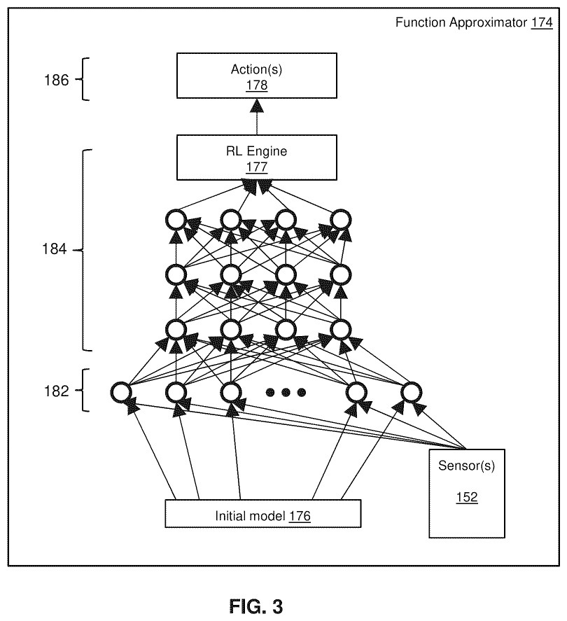

Turning to FIG. 3, various functions of controller 202 may be implemented via a function approximator 174 (e.g., any mathematical or algorithmic object capable of estimating an unknown function). A neural network is one example of a component that may be implemented as function approximator 174. Function approximator 174 is shown via a schematic diagram to further illustrate processes for operating autonomous agent(s) 110 according to the disclosure. Function approximator 174 can relate one or more input variables (e.g., an initial model 176 contained within, e.g., a library of training data) to various actions to be performed via, e.g., actuators 112 of autonomous agent 110. Initial model(s) 176 may represent initial models of possible value functions to be implemented via autonomous agent(s) 110, and/or modified value functions produced from past instances of operating autonomous agent(s) 110 and/or other devices. As initial model(s) 176 is/are submitted to function approximator 174, algorithms included in function approximator 174 can be iteratively adjusted in a reinforcement learning engine (RL engine) 177 based on comparing various outputs (e.g., action(s) 178) to verified, ideal values and/or other related groups of inputs and outputs (e.g., data produced from undertaking other missions within environment 100, other operations performed by autonomous agent(s) 110, etc.).

A layer of inputs 182 includes environmental and/or non-environmental inputs provided to function approximator 174, which can include, e.g., input(s) provided via user(s) 122, element(s) 126, and/or environmental cues 128. Inputs 182 can together define multiple nodes. Each node and respective input 182 may be connected to other nodes in a hidden layer 184, which represents particular mathematical functions. In embodiments of the present disclosure, inputs 182 can include, e.g., initial model(s) 176 for relating various inputs to recommended action(s) 178. Each node of hidden layer 184 can include a corresponding weight representing a factor or other mathematical adjustment for converting input variables into output variables. The nodes of hidden layer 184 can eventually connect to reinforcement learning engine 177, which in turn connects to output node(s) 186 from function approximator 174 in the form of recommended action(s) 178 to be implemented, e.g., via actuator(s) 112. Function approximator 174 may receive environmental and/or non-environmental inputs from sensor(s) 152 for immediate processing as part of the layer of input(s) 182. However, it is understood that input(s) from sensor(s) 152 also may additionally or alternatively be included in hidden layer 184 in other implementations. In embodiments of the disclosure, output 186 from function approximator 174 can include causing autonomous agent(s) 110 to advance along pathway(s) J1, J2, and/or perform various other actions.

To increase the effectiveness of its predictions, function approximator 174 can compare outputs 186 (e.g., various recommended actions 178) with user-defined and/or or target (e.g., ideal) values, e.g., from post-mission analysis of other autonomous agent(s) 110 and/or other operations performed in environment 100, to calculate errors in a process known as “error backpropagation.” Such errors may include, e.g., action(s) 178 causing autonomous agent(s) 110 to attempt to re-establish a communications link with network gateway(s) 120, instead of continuing on a path toward a given objective, delivering payload(s) 124 (FIG. 1) when the mission has been called off, etc. Where the error between the value function of various outputs 186 and a recommended or known alternative exceeds a particular threshold, function approximator 174 can include processes for self-correction. For example, process steps encoded in hardware and/or software can use outputs 186 to adjust weights W of hidden layer 184 and or connections between inputs 182 to hidden layer 184 and/or output(s) 186.

Function approximator 174 can take the form of any conceivable machine learning system, and examples of such systems are described herein. In one scenario, function approximator 174 may include or take the form of an artificial neural network (ANN), and more specifically can include one or more sub-classifications of ANN architectures, whether currently known or later developed. In one example, function approximator 174 can take the form of a “convolutional neural network,” for predicting action(s) from initial model 176 and modification via environmental and/or non-environmental inputs. Convolutional neural networks may be distinguished from other neural network models, e.g., by including individual nodes in each layer which respond to inputs in a restricted region of a simulated space known as “a receptive field.” The receptive fields of different nodes and/or layers can partially overlap such that they together form a depiction of a visual field (e.g., environment 100 and element(s) 126 therein, represented in two-dimensional or three-dimensional space). The response of an individual node to inputs within its receptive field can be approximated mathematically by a convolution operation. In another example, function approximator 174 can take the form of a multilayer perceptron (MLP) neural network. MLP neural networks may be distinguished from other neural networks, e.g., by their lack of restrictions on the interactions between hidden nodes and lack of parameter sharing. Neural networks may be particularly suitable for sets of data, which may be not linearly separable by conventional mathematical techniques. Other function approximation regimes include weighted linear/nonlinear Fourier basis or polynomial basis functions. Regardless of the chosen architecture of function approximator 174, the various processes for training function approximator 174 and/or expanding the information included in initial model(s) 176 and/or corresponding training data implemented with embodiments of the present disclosure can be similar or identical.

Portions of hidden layer 184 for interacting with sensor(s) 152 may include and/or interact with a natural user interface (NUI). NUIs differ from Graphical User Interfaces (GUIs) in that they aim to be more intuitive to user(s) 122, and are designed to allow a human to interact with autonomous agent(s) 110 via the NUI in a way that they may expect to act with a human. Due to this requirement, NUIs often focus on environmental cues 128 (e.g., gestures, visual signals, and/or audio commands) as inputs to be detected via sensor(s) 152. For a scenario of tactically controlling autonomous agent 110, audio commands (even over wireless data links) may be ineffective if or when sensor(s) 152 are not within audible range of user(s) 122 or noise from/within environment 100 produces an unfavorable signal to noise scenario. In this case, the NUI design can be capable of accepting and interpreting visual cues and gestures sensed via sensor(s) 152. Not only does the introduction of a NUI into autonomous agent(s) 110 improve the efficacy of a human-machine team, but additionally enables interaction with autonomous agent(s) 110 in scenarios where data communication links to from other autonomous agent(s) 110 and/or network gateway(s) 120 have been compromised or are ineffective.

As noted herein, sensor(s) 152 may be capable of receiving and/or interpreting a variety of environmental cues 128. Environmental cues 128 thus may include, for example, a physical wave off by a person (e.g., a type of element 126) in environment 100 to signal autonomous agent 110 to abort landing, a “come here” gesture to signal that a landing site (e.g., second location L2) is now safe, a “stay” gesture to signal autonomous agent(s) 110 to continue its trajectory along pathway(s) J1, J2, hover in place, etc. Element(s) 126 of environment 100 themselves may also be used to signal autonomous agent(s) 110 to perform certain behaviors, and often come in the form of a chromatic signal or the use of other objects. For example, element(s) 126 in the form of stationary flags within environment 100 may signal autonomous agent(s) 110 to perform different actions, and/or other types of objects may be sensed by sensor 152 to trigger functions similar in nature to a flash card, that direct function approximator 174 to favor certain action(s) 178.

Although the use of an NUI may be effective when autonomous agent(s) 110 is/are in environment 100, it is understood that a GUI will remain available to user(s) 122 so that they may monitor or intervene in a mission as required. In the design of the GUI, information representation and/or management techniques can contextualize various forms of data, including environmental and/or non-environmental inputs sensed by sensor(s) 152 to allow user(s) 122 to most efficiently process the provided information and make decisions. The user interface(s), including an NUI and/or GUI where applicable, cooperate to exchange data between autonomous agent(s) 110 and interconnected devices (e.g., autonomous agent(s) 110, network gateway(s) 120, user(s) 122), element(s) 126, environmental cues 128, and/or other items in environment 100. It is understood that when various types of information (e.g., environmental and/or non-environmental inputs) are submitted to function approximator 174, autonomous agent 110 will react by performing any of several action(s) 178. To achieve this goal, function approximator 174 may implement an operative policy selected from several candidate policies as proposed in the system framework.

Directives from human operators, regardless of which part of an interface delivers them to autonomous agent(s) 110, have the ability to change the current operating policy. This change in policy will change the value signal that function approximator 174 associates with certain action(s) 178, thus signifying that controller 202 must change the behavior of autonomous agent 110 to maximize value. In this case, autonomous agent(s) 110 will subsequently perform the desired action(s) 178.

Function approximator 174 may implement further machine learning techniques to better associate changing mission objectives with various action(s) 178. Function approximator 174 may implement any currently known or later developed machine learning technique for training autonomous agent 110 to create and/or select new policies, e.g., when access to external data through transceiver(s) 116 is limited or when autonomous agent 110 is not operating. Constrained Offline Policy Optimization (COPO) is one type of reinforcement-learning paradigm in which hidden layer(s) 184 of function approximator 174 may use distribution correction estimates to estimate a candidate policy's performance in environment 100 using data collected from the other operative policies. Confidence interval estimates on the breakage of constraints allow user(s) 122 to be confident in the performance of autonomous agent(s) 110 even during a first deployment within environment 100. High Confidence Off-Policy Improvement (HCOPI) is another such reinforcement learning algorithms, which uses importance sampling (IS) estimators to accomplish similar ends. When used with a Seldonian Optimization Algorithm (SOA), HCOPI provides similar confidence intervals. Other similar algorithms include but not limited to AlgaeDICE and Constrained Batch Policy Learning.

Autonomous agent(s) 110 may not perform as expected when initially deployed in environment 100. This concern may be especially problematic in the case of aerial-deployed autonomous agent(s) 110, as a hardware system error may physically crash and destroy autonomous agent(s) 110 in the case that controller 202 fails to accurately interpret various environmental and/or non-environmental inputs with respect to environment 100. To mitigate such risks, embodiments of the disclosure collect data relating to autonomous agent 110 trajectories within environment 100 and use them to adjust the operative policy and/or select a new policy that is safe for deployment. The modifying and/or selecting of policies may use data from statistical location and mapping (SLAM) navigation techniques. While the SLAM navigation algorithm may have disadvantages (e.g., increased processing time) in some types of environments 100, it generally keeps autonomous agent(s) 110 from crashing when this is a significant risk. Once trajectory data is collected for the operative policy, new policies may be proposed, or found using optimization algorithms. The anticipated performance of such policies when implemented via autonomous agent(s) 110 can be estimated using the trajectory data from the operative policy. Since confidence bounds can be obtained from an estimator, the acceptable confidence range can be set as high as desired (e.g., by user(s) 122) to further define proper behaviors in the new operative policy (ies).

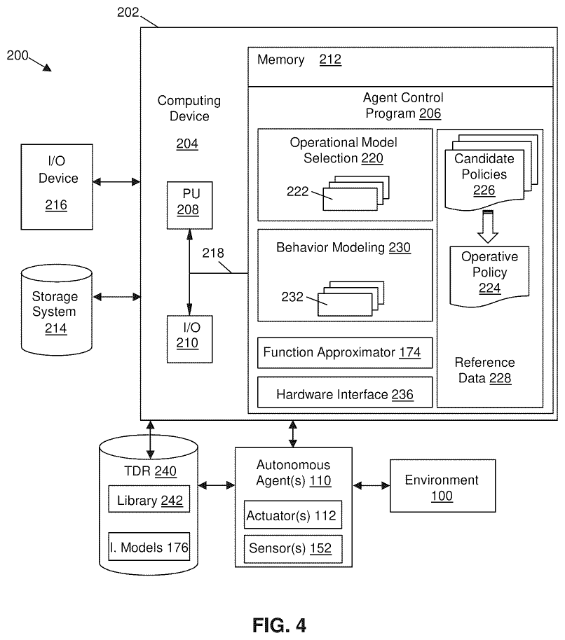

Turning now to FIG. 4, an illustrative system 200 for implementing the methods and/or systems described herein is shown. In particular, controller 202 is shown as including a computing device 204. Computing device 204 can include, e.g., an agent control program 206 which may include, e.g., one or more sub-systems (operational model selection program 220 and/or behavioral modeling program 230 described herein) for performing any/all of the processes described herein and implementing any/all of the embodiments described herein.

Controller 202 is shown including a processing unit (PU) 208 (e.g., one or more processors), an I/O component 210, a memory 212 (e.g., a storage hierarchy), an external storage system 214, an input/output (I/O) device 216 (e.g., one or more I/O interfaces and/or devices), and a communications pathway 218. In general, processing unit 208 can execute program code, such as agent control program 206, which is at least partially fixed in memory 212. While executing program code, processing unit 208 can process data, which can result in reading and/or writing data from/to memory 212 and/or storage system 214. Pathway 218 provides a communications link between each of the components in system 200. I/O component 210 can comprise one or more human I/O devices, which enable a human user to interact with controller 202 and/or one or more communications devices to enable a system user to communicate with the controller 202 using any type of communications link. To this extent, agent control program 206 can manage a set of interfaces (e.g., graphical user interface(s), application program interface(s), etc.) that enable system users to interact with agent control program 206. Further, agent control program 206 can manage (e.g., store, retrieve, create, manipulate, organize, present, etc.) data, through several modules contained within operational model selection program 220 (i.e., modules 222) and/or behavioral modeling program 230 (i.e., modules 232). Operational model selection program 220 and behavioral modeling program 230 are shown by example as being sub-systems of agent control program 206. However, it is understood that operational model selection program 220 and behavioral modeling program 230 may be wholly independent systems. Memory 212 of computing device 204 is also shown to include a hardware interface 236 for translating outputs from agent control program 206 into actions performed in autonomous agent(s) 110, though it is understood that hardware interface 236 may be included within one or more independent computing devices, programs, etc., in alternative embodiments.

As noted herein, agent control program 206 can include operational model selection program 220 and behavioral modeling program 230. In this case, various modules 222 of operational model selection program 220 and modules 232 of behavioral modeling program 230 can enable controller 202 to perform a set of tasks used by agent control program 206, and can be separately developed and/or implemented apart from other portions of agent control program 206. Memory 212 can thus include various software modules 222, 232 of programs 220, 230 configured to perform different actions. Example modules can include, e.g., a comparator, a calculator, a determinator, etc. One or more modules 222, 232 can use algorithm-based calculations, look up tables, software code, and/or similar tools stored in memory 212 for processing, analyzing, and operating on data to perform their respective functions. Each module discussed herein can obtain and/or operate on data from exterior components, units, systems, etc., or from memory 212 of computing device 204.

Sets of modules 222, 232 of operational model selection program 220 and behavioral modeling program 230 can perform functions of controller 202 in various implementations. Operational model selection program 220 can include, e.g., modules 222 for selecting an operative policy 224 for agent control program 206 to implement in controlling autonomous agent(s) 110. Operative policy 224 can be selected from a several different candidate policies 226. Candidate policies 226 may represent alternative mission objectives (e.g., delivery of payload, returning to base, restoring a data link, etc.), and/or may include alternate prioritizing of different objectives, different ways of accomplishing the same objectives, etc. Operative policy 224 and candidate policies 226 may be included in memory 212 as a database of reference data 228 expressed, e.g., through a list, graphical representation, and/or other organizational structure based on the characteristics of each candidate policy. Operational model selection program 220, in some cases, may use function approximator 174 to evaluate candidate policies 226 based on their value functions in a particular situation. In addition, operational model selection program 220 can receive and interpret incoming data from sensor(s) 152, and/or rely on such interpretations in function approximator 174, to evaluate the value function for each of candidate policies 226. Operational model selection program 220 thus may select one of candidate policies 226 for implementation as operative policy 224, in the event that a previous operative policy 224 has been terminated.

The various inputs that modules 222 may use for selecting operative policy 226 can be provided to computing device 204, e.g., through I/O device 216. Some inputs concerning environment 100 can be converted into a data representation (e.g., a data matrix with several values corresponding to particular attributes) and stored electronically, e.g., within memory 212 of computing device 204, storage system 214, and/or any other type of data cache in communication with computing device 204. Images and/or other representations of environment 100, element(s) 126, environmental cues 128, etc., can additionally or alternatively be converted into data inputs or other inputs to agent control program 206 with various scanning or extracting devices, connections to independent systems, and/or manual entry by user(s) 122. As an example, user(s) 122 of computing device 204 and/or network gateway 120 can submit data to be included in library 242 to TDR 240. Such data submitted to TDR 240 may originate from other instances of operating autonomous agent(s) 110, other missions performed in environment 100, and/or projected policies, e.g., candidate policies 226 and/or other policies proposed for implementation on autonomous agent 110. Library 242 also may include, e.g., data pertaining to the movement and/or trajectory of autonomous agent(s) 110, technical data of autonomous agent(s) 110 such as remaining power and/or communication frequencies, various aspects of operator-controlled system(s) 130 (FIG. 1), various aspects of another device 132 (FIG. 1) irrespective of whether it is autonomously controlled, and/or various aspects of other elements 126 within environment 100 (e.g., vehicle serial numbers, personnel name and position, infrastructure status, etc.). Behavioral modeling program 230 can then apply function approximator 174 to select actions for autonomous agent(s) 110 to perform, e.g., by causing hardware interface 236 to manipulate actuator(s) 112. TDR 240 and/or agent control program 206 can thereafter receive initial models 176 as a further input, and behavioral modeling program 230 can determine whether the selected operative policy 224 is appropriate based on subsequently received environmental and/or non-environmental inputs.

As discussed herein, agent control program 206, including function approximator 174, can create new or adjusted candidate policies 226 for possible selection and use as operative policy 224. As described elsewhere herein function approximator 174 can include multiple layers of models, calculations, etc., each including one or more adjustable calculations, logical determinations, etc., through any currently-known or later developed analytical technique for predicting an outcome based on raw data. Function approximator 174 can therefore use various types of data in a training data repository (TDR) 240. TDR 240 may include, e.g., a library 242 of past inputs and/or similar inputs archived in TDR 240. TDR 240 additionally or alternatively may include initial models 176 to be modified, trained, and/or otherwise used as a reference for creating and/or selecting between candidate policies 226, as well as for further adjusting of function approximator 174 as discussed herein. Example processes executed with function approximator 174 and/or agent control program 206 are discussed in detail elsewhere herein. Modules 222 of operational model selection program 220 and modules 232 of behavioral modeling program 230 can implement one or more mathematical calculations and/or processes, e.g., to execute the machining learning and/or analysis functions of function approximator 174.

Behavioral modeling program 230 can include a corresponding set of modules 232 for executing functions of agent control program 206, discussed herein. Modules 232 of behavioral modeling program 230 can include, e.g., a determinator for making logical determinations based on one or more inputs. Modules 232 of behavioral modeling program 230 can perform one or more actions relating to the training of function approximator 174, e.g., submitting data from TDR 240, autonomous agent(s) 110, and/or memory 212 to expand the amount of reference data used by function approximator 174. Other functions of modules 232 can include, projecting the effect of sensor 152 inputs on the value function(s) of candidate policies 224 and/or operative policy 226 to provide additional training data for function approximator 174. Behavioral modeling program 230 can include modules 232 for “flagging” (e.g., marking, indexing, and/or otherwise identifying) previously selected candidate policies 224 for particular situations, e.g., to indicate whether they are more likely to have a high value function under known circumstances indicated via sensor(s) 152. Modules 232 of behavioral modeling program 230, in addition, can modify function approximator 174 by adjusting variables, coefficients, weights threshold values, reference values, etc., based on various information in TDR 240 and/or memory 212. Modules 232 of behavioral modeling program 230 can also include a calculator for carrying out various mathematical operations, e.g., to adjust function approximator 174 as prescribed by other processes. In other embodiments, modules 232 of behavioral modeling program 230 may be used to adjust function approximator 174.

Controller 202 can be operatively connected to or otherwise in communication with autonomous agent(s) 110, as part of the operational model selection program 220 for control of autonomous agent(s) 110. Controller 202 can thus be embodied as a unitary device coupled to autonomous agent(s) 110 and/or other devices, or can be multiple devices each operatively connected together to form controller 202. Embodiments of the present disclosure may include using function approximator 174 to select action(s) 178 (FIG. 3), based on environmental and/or non-environmental inputs detected in sensor(s) 152 and an operative policy implemented in model selection program 220. In cases where the operative policy is terminated, behavioral modeling program 230 can select a new operative policy based on, e.g., inputs detected through sensor(s) 152. As discussed herein, embodiments of the present disclosure thereby provide machine learning processes for control of autonomous agent(s) in response to various environmental and/or non-environmental inputs.

Where controller 202 comprises multiple computing devices, each computing device may have only a portion of agent control program 206, operational model selection program 220, and/or behavioral modeling program 230 fixed thereon (e.g., one or more modules 222, 232). However, it is understood that controller 202 and operational model selection program 220 are only representative of various possible equivalent computer systems that may perform a process described herein. Controller 202 can obtain or provide data, such as data stored in memory 212 or storage system 214, using any solution. For example, controller 202 can generate and/or be used to generate data from one or more data stores, receive data from another system, send data to another system, etc.

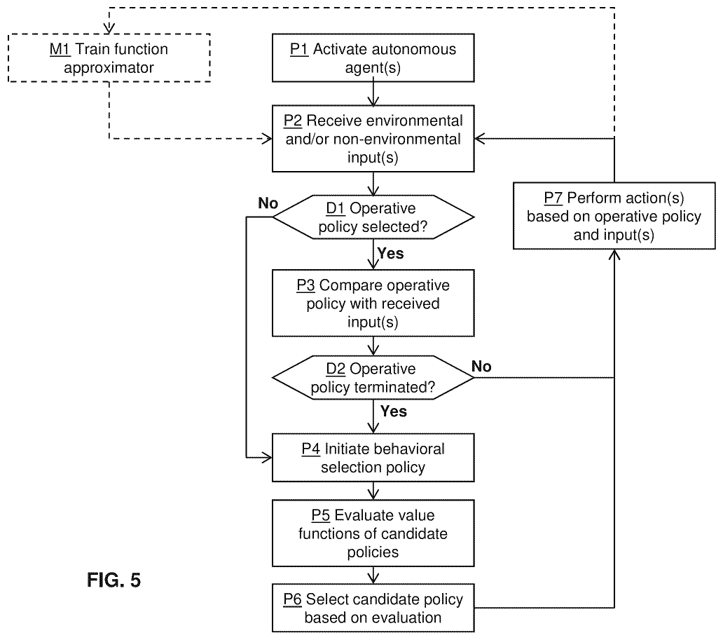

Referring now to FIGS. 1, 4, and 5, in which FIG. 5 illustrates an example flow diagram of for methods of the disclosure that may be implemented through controller 202 (FIGS. 1, 4) of system 200 (FIG. 4), operational methodologies according to the disclosure are discussed. Process P1 may include, e.g., activating autonomous agent(s) 110. The activating of autonomous agent(s) 110 may include, e.g., causing autonomous agent(s) 110 to begin acting within environment 100, simply placing autonomous agent(s) 110 in communication with other devices in environment 100 and/or the same network, and/or simply powering on autonomous agent(s) 110. Upon activation in process P1, autonomous agent(s) 110 may be capable of performing actions and/or receiving environmental and/or non-environmental inputs via sensor(s) 152, transceiver(s) 116, and/or other communication components.

Process P2 may be implemented with autonomous agent 110 in an activated (e.g., operating) state, and may include receiving environmental and/or non-environmental inputs for process and/or interpretation. Such inputs may be detected via sensor(s) 152 of autonomous agent(s) 110, and/or may be received from other devices (including other autonomous agent(s) 110) via transceiver(s) 116 and/or other data communications links. The environmental and/or non-environmental inputs received in process P2 may relate to general information about environment 100 and/or circumstances regarding the mission(s) being undertaken. As discussed elsewhere herein, the various inputs may include information provided from user(s) 122 via a GUI, and/or various elements 126 and/or environmental cues 128 detected through sensor(s) 152, e.g., by way of an NUI. The inputs provided to autonomous agent(s) 110 in process P2 may form the basis for other determinations and/or decisions of other processes described herein.

After receiving relevant inputs in process P2 and/or allowing autonomous agent 110 to operate for a prescribed time interval, methods of the disclosure may include decision D1 of evaluating whether any of candidate policies 226 have already been selected as operative policy 224 for determining further operations of autonomous agent 110. In the case that operative policy 224 has not already been selected (i.e., “no” at decision D1), the method may continue to further operations for selecting operative policy 224 from candidate policies 226. In the case that operative policy 224 has already been selected (i.e., “yes” at decision D1), the method may continue to functions for further evaluating of operative policy 224. In process P3 in embodiments of the disclosure, modules 232 of behavior modeling program 232 can evaluate whether any of the inputs received in process P2 indicate that operative policy 224 has been terminated. The evaluation in process P3 may include, e.g., comparing one or more of the received inputs with a catalogue of possible inputs that indicate termination of operative policy 224 (e.g., data connections being unavailable for at least a threshold time interval, coordinates being outside particular boundaries, environmental cue(s) 128 being identified, etc.). In decision D2, agent control program 206 determines whether operative policy 224 is terminated. In the case that operative policy 224 is not terminated (i.e., “No” at decision D2), the method may continue to other processes for implementing actions in compliance with operative policy 224. In the case that operative policy 226 is terminated (i.e., “Yes” at decision D2), the method proceeds to operations P4-P6 to select another operative policy 224.

Process P4 in methods of the disclosure may include causing behavioral modeling program 230 to initiate a “behavioral selection policy.” A behavioral selection policy is a process by which autonomous agent 110 may temporarily cease implementing further actions apart from maintaining a position, status, activity, etc., while controller 202 selects another operative policy 224. Thus, process P4 may include terminating certain ongoing processes, e.g., traveling a particular destination, attempting to restore a data communications link to other autonomous agent(s) 110 and/or network gateway(s) 120, etc. In process P4, modules 232 of behavioral modeling program 230 may cause certain actuator(s) 112 of autonomous agent 110 to continue operating, e.g., to maintain operation and/or avoid a possible systems failure.

After behavioral modeling program 230 initiates the behavioral selection policy in process P4, embodiments of the disclosure proceed to process P5 of evaluating the value functions of each candidate policy 226. The evaluation may be implemented, e.g., via function approximator 174 based on initial model(s) 176 and input(s) provided from sensor(s) 152. Initial model(s) 176 themselves may be trained based on information stored within library 242 and/or any other data fields of TDR 240. In process P5, modules 232 (including, e.g., a calculator operating in tandem with function approximator 174) of behavioral modeling program 230 can evaluate the value function of candidate policies 226 and corresponding action(s) 178 that would be implemented. The evaluation can be based on, e.g., the effect of environmental inputs and non-environmental inputs on the value functions in each candidate policy 226. After evaluating a group of candidate policies 226 selected for analysis, the method may continue to process P6 of selecting one candidate policy 226 (e.g., one with the highest value function) to be designated as operative policy 224. After one candidate policy 226 is designated as operative policy 224, the method may continue to process P8 of causing autonomous agent(s) 110 to perform actions based on operative policy 224. Process P7 alternatively may be implemented after decision D2, in cases where an existing operative policy 224 is not terminated. The method may return to process P2 of receiving additional environmental and/or non-environmental inputs, or further processes to train function approximator 174 may be implemented.

Embodiments of the disclosure may overcome the limitations of other control paradigms for autonomous agents, e.g., my modifying function approximator 174 even when data communications to certain other autonomous agent(s) 110 and/or network gateways 120 are not available. In this case, methods according to the disclosure may optionally include operation M1 for training function approximator 174 after process P7 concludes. In cases where further data communication to other autonomous agents 110 and/or network gateways 120 is possible, operation M1 may include receiving additional candidate policies 226 and/or modifications to function approximator 174, e.g., from user(s) 122.

In an example, operation M1 may include further training of function approximator 174 using an offline reinforcement learning algorithm. An online reinforcement algorithm may include any of the various example reinforcement learning solutions discussed elsewhere herein, and/or any other machine learning platform capable of training function approximator 174 via inputs received in sensor(s) 152 and/or other data included in TDR 240. However embodied, the applicable reinforcement learning algorithm may affect the number and/or content of candidate policies 226 for the next selection of operative policy 224. For example, operation M1 may include modifying one or more of candidate policies 226 based on library 242 in TDR 240. This modifying may be implemented without access to certain types of data, e.g., other autonomous agent(s) 110, network gateways 120, and/or other repositories of reference data that would otherwise be accessed via transceiver 116. After modifying candidate policy (ies) 226 based on available data, the modified candidate policy (ies) 226 may be added to the group of all candidate policies 226 in memory 212.

In an example implementation, the training of function approximator 174 in operation M1 may include using a constraint projection to transform a non-viable policy (e.g., a policy that breaks a maximum speed constraint) into a “safe” counterpart that is capable of being implemented. In this case, the modified candidate policy 226 provides a next-closest alternative to terminated and/or non-viable functions that can be considered in subsequent selecting of operative policy 224. In this case, the original version of some candidate policy (ies) 226 may remain in memory 212 such that they are available under changing circumstances (e.g., the removal of restrictions that previously caused one candidate policy 226 to be non-viable).

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present disclosure may take the form of a computer program product embodied in one or more computer readable medium(s) having computer readable program code embodied thereon.

Any combination of one or more computer readable medium(s) may be used. A computer readable storage medium may be, for example, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the layout, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As used herein, the term “configured,” “configured to” and/or “configured for” can refer to specific-purpose patterns of the component so described. For example, a system or device configured to perform a function can include a computer system or computing device programmed or otherwise modified to perform that specific function. In other cases, program code stored on a computer-readable medium (e.g., storage medium), can be configured to cause at least one computing device to perform functions when that program code is executed on that computing device. In these cases, the arrangement of the program code triggers specific functions in the computing device upon execution. In other examples, a device configured to interact with and/or act upon other components can be specifically shaped and/or designed to effectively interact with and/or act upon those components. In some such circumstances, the device is configured to interact with another component because at least a portion of its shape complements at least a portion of the shape of that other component. In some circumstances, at least a portion of the device is sized to interact with at least a portion of that other component. The physical relationship (e.g., complementary, size-coincident, etc.) between the device and the other component can aid in performing a function, for example, displacement of one or more of the device or other component, engagement of one or more of the device or other component, etc.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system for control of an autonomous agent, the system comprising:
a sensor communicatively coupled to the autonomous agent and configured for receiving a set of inputs, the sensor including an environmental sensor and a non-environmental sensor;
at least one actuator for causing the autonomous agent to perform an action; and
a controller communicatively coupled to the sensor and the at least one actuator, wherein, the controller is configured to perform actions including:
causing the at least one actuator to perform the action based on the set of inputs and an operative policy;
determining whether the set of inputs indicates termination of the operative policy;
evaluating a value function for each of a plurality of candidate policies based on the set of inputs, in response to the set of inputs indicating termination of the operative policy; and
selecting one of the plurality of candidate policies as a new operative policy.

2. The system of claim 1, wherein the controller includes at least one function approximator configured to evaluate the value function based on the set of inputs, a library of training data, and past instances of selecting one of the plurality of candidate policies.

3. The system of claim 2, wherein the library of training data includes data corresponding to a different autonomous agent, another device, or an operator-controlled system operating in the same environment.

4. The system of claim 2, wherein the controller is further configured to train the function approximator or produce a projected policy for the autonomous agent based on an offline reinforcement learning algorithm.

5. The system of claim 4, wherein the offline reinforcement learning algorithm performs actions including:
modifying a candidate policy based on the library of training data; and
designating the modified candidate policy as part of the plurality of candidate policies.

6. The system of claim 1, wherein the non-environmental sensor includes a transceiver configured to receive a direct user input, or data from a different autonomous agent.

7. The system of claim 1, wherein the environmental sensor includes a camera configured for visually monitoring an environment.

8. A method for control of an autonomous agent, the method comprising:
causing the autonomous agent to sense a set of inputs via an environmental sensor and a non-environmental sensor;
causing at least one actuator of the autonomous agent to perform an action, based on the set of inputs and an operative policy;
determining whether the set of inputs indicates termination of the operative policy;
evaluating a value function for each of a plurality of candidate policies based on the set of inputs, in response to the set of inputs indicating termination of the operative policy; and
selecting one of the plurality of candidate policies as a new operative policy.

9. The method of claim 8, further comprising evaluating the value function with a function approximator, and based on the set of inputs, a library of training data, and past instances of selecting one of the plurality of candidate policies.

10. The method of claim 9, wherein the library of training data includes data corresponding to a different autonomous agent, another device, or an operator-controlled system operating in the same environment.

11. The method of claim 9, further comprising training the function approximator or produce a projected policy for the autonomous agent based on an offline reinforcement learning algorithm.

12. The method of claim 11, further comprising causing the offline reinforcement learning algorithm to perform actions including:
modifying a candidate policy based on the library of training data; and
designating the modified candidate policy as part of the plurality of candidate policies.

13. The method of claim 8, wherein causing the autonomous agent to sense the set of inputs includes causing a transceiver configured to receive a direct user input, or data from a different autonomous agent.

14. The method of claim 8, wherein causing the autonomous agent to sense the set of inputs includes causing a camera configured to visually monitor an environment.

15. A computer program product for control of an autonomous agent, the computer program product comprising a computer readable storage medium on which is stored program code for causing a computer system to perform actions including
causing the autonomous agent to sense a set of inputs via an environmental sensor and a non-environmental sensor;
causing at least one actuator of the autonomous agent to perform an action, based on the set of inputs and an operative policy;
determining whether the set of inputs indicates termination of the operative policy;
evaluating a value function for each of a plurality of candidate policies based on the set of inputs, in response to the set of inputs indicating termination of the operative policy; and
selecting one of the plurality of candidate policies as a new operative policy.

16. The computer program product of claim 15, further comprising program code for evaluating the value function with a function approximator, and based on the set of inputs, a library of training data, and past instances of selecting one of the plurality of candidate policies.

17. The computer program product of claim 16, wherein the library of training data includes data corresponding to a different autonomous agent, another device, or an operator-controlled system operating in the same environment.

18. The computer program product of claim 16, further comprising program code for training the function approximator or produce a projected policy for the autonomous agent based on an offline reinforcement learning algorithm.

19. The computer program product of claim 18, further comprising program code for causing the offline reinforcement learning algorithm to perform actions including:
modifying a candidate policy based on the library of training data; and
designating the modified candidate policy as part of the plurality of candidate policies.

20. The computer program product of claim 15, wherein the program code for causing the autonomous agent to sense the set of inputs includes causing a transceiver configured to receive a direct user input, or data from a different autonomous agent, and the program code for causing the autonomous agent to sense the set of inputs includes causing a camera configured to visually monitor an environment.
